(19) United States
(12) Patent Application Publication
(10) Pub. No.: US 2012/0191286 A1
(43) Pub. Date: Jul. 26, 2012

(54) STEERING ARRANGEMENT FOR A VEHICLE WHICH IS MOVABLE ALONG A PREDEFINED PATH IN USE, BEING AUTOMATICALLY STEERED VIA AT LEAST ONE FIRST AXLE, AS WELL AS A VEHICLE PROVIDED WITH SUCH A STEERING ARRANGEMENT

(75) Inventors: Rudolf Mathijs Jozef Bouwman, Hamont (BE); Jean Luc Valk, Eindhoven (NL)

(73) Assignee: ADVANCED PUBLIC TRANSPORT SYSTEMS B.V., Helmond (NL)

(21) Appl. No.: 13/395,276

(22) PCT Filed: Sep. 13, 2010
(86) PCT No.: PCT/NL2010/050580

§ 371 Date: Apr. 13, 2012

(30) Foreign Application Priority Data
Sep. 11, 2009 (NL) 1037275

(51) Int. Cl. G05D 1/02

(52) U.S. Cl. 701/25

(57) ABSTRACT

A steering arrangement for a vehicle which is movable along a predefined path in use, being automatically steered via at least one first axle. Also disclosed is a vehicle provided with such a steering arrangement. The steering arrangement is for use in an automatically guided and steered vehicle, i.e. without a driver, wherein the steering arrangement can continue to influence the steerage of the vehicle for a minimum period of time in case of a malfunction, such that the risk of dangerous situations or accidents is minimized.

### PRIORITY CLAIM

This patent application is a U.S. National Phase of International Patent Application No. PCT/NL2010/050580, filed 13 Sep. 2010, which claims priority to Dutch Patent Application No. 1037275, filed 11 Sep. 2009, the disclosures of which are incorporated herein by reference in their entirety.

### FIELD

One disclosed embodiment relates to a steering arrangement for a vehicle which is movable along a predefined path in use, being automatically steered via at least one first axle.

Another disclosed embodiment relates to a vehicle provided with such a steering arrangement.

### BACKGROUND

In public transport systems, and in particular in transport systems which make use of passenger buses, there is a continuous search for new developments that must make it possible, in particular in densely populated areas, to provide the public with a fast, comfortable and high-frequency public transport system.

A development that is frequently used already is the adaptation of the infrastructure, which involves the construction of special lanes intended only for public transport. This makes it possible to handle large passenger flows, in particular during the rush hours, with the means of public transport hardly, if at all, being impeded by other traffic flows.

At present there is an additional development is in progress, according to which the vehicle is guided and steered along a predefined path. The path generally consists of a lane specially reserved for this purpose within the infrastructure, which infrastructure may or may not exist yet, which lane is in principle closed to the other road users.

The guidance of such a guided and steered vehicle is realized, for example, by installing passive (for example magnetic) markers in the road surface, which markers are detected by a path tracking system in the vehicle, on the basis of which the steering arrangement of the guided and steered vehicle may make adjustments as regards the direction to be followed and the vehicle speed. Instead of using markers in the road surface it is also possible to use other tracking systems, for example reflectors and GPS. In use, the path tracking system will minimize a detected deviation of the vehicle from the predefined path as much as possible.

The safety of the passengers being transported in such an automatically guided and steered vehicle is an important point of consideration. Such a vehicle must, therefore, be provided with means for preventing dangerous situations that may occur in case of a malfunction in the steering arrangement. It is in particular desirable that the steering function of the steering arrangement (and consequently also the path tracking system) remain operational in case of a malfunction in the steering arrangement, for example because part of the steering function is lost.

### SUMMARY

The disclosed embodiments provide a steering arrangement for use in a guided and steered vehicle, which steering arrangement can continue to influence the steerage of the vehicle for a minimum period of time, and independently of a driver who may be present, in case of a malfunction, such that the risk of dangerous situations or accidents is minimized.

### BRIEF DESCRIPTION OF THE DRAWINGS

The disclosed embodiments will now be explained in more detail with reference to the drawings, in which:

FIG. 1 shows a schematic illustration of an automatically guided and steered vehicle in a specific lane;

FIG. 2 shows a first embodiment of a steering arrangement for an automatically guided and steered vehicle;

FIG. 3 shows another embodiment of a steering arrangement for an automatically guided and steered vehicle; and

FIGS. 4-6 show embodiments of a steering arrangement.

### DETAILED DESCRIPTION

In order to further minimize undesirable deviation from the predefined path in case of a malfunction in the steering arrangement, for example, at high speeds, the steering arrangement comprises a path tracking system comprising information characteristics relating to the predefined path to be followed; path sensor means designed to detect a deviation from the predefined path by the vehicle; and steering means designed to steer the at least first axle so as to correct the detected deviation from the path; as well as a guidance control system for controlling the steering means, wherein the guidance control system comprises at least three mutually verifying arithmetic units, such that, in case of a detected malfunction in one of the arithmetic units, the other arithmetic units will disable the arithmetic unit in question.

In case of failure of at least part of the steering arrangement due to a malfunction, corrective measures regarding the failing steerage of the vehicle can be taken very quickly, which suffices for making timely steerage adjustments and stopping the vehicle within a very short period of time. In this way the vehicle is in any case prevented from deviating from its predefined path in an uncontrolled manner in case of a malfunction, but steerage adjustments will be made by one of the other independently operating drivelines.

In this way, the functionality of the steering arrangement is guaranteed, in particular when the vehicle is moving at a higher speed, in which case an unforeseen deviation from the predefined path could lead to unacceptable, dangerous situations. Thus, quick and adequate corrective action can be taken, making it possible to minimize a deviation from the predefined path of the vehicle, even at high speeds, and to stop the vehicle in time.

According to another disclosed embodiment, each arithmetic unit generates a control signal during operation, wherein the control system is characteristic of the current operating state of the steering arrangement as determined by the arithmetic unit in question, which control signal serves as an input signal for the other arithmetic units.

More specifically, each arithmetic unit compares each control signal from the arithmetic unit in question that is input with the control signal it has generated itself, and on the basis of this comparison it generates a verification signal for the arithmetic unit in question. Thus, an internal verification possibility is created, so that any errors and malfunctions in the system will be detected.

If the control signals correspond to each other, each arithmetic unit will generate a positive verification signal, which implies that the arithmetic units are functioning correctly, whereas in the case of a malfunction each arithmetic unit will generate a negative verification signal if the control signals do not correspond to each other.

In order to realize an adequate handling of malfunctions, each verification signal generated for a respective arithmetic unit serves as an input signal for an authorization unit for the arithmetic unit in question, each of which authorization units can be put in a pass-through state or a blocking state partially on the basis of the input verification signals. This makes it possible to disable a nonfunctioning arithmetic unit.

According to one disclosed embodiment, each authorization unit comprises at least one AND gate provided with an input for a verification signal, whilst furthermore each authorization comprises at least one second AND gate provided with an input for at least one other verification signal.

According to this disclosed embodiment, each AND gate is provided with a further input for a verification signal generated by the arithmetic unit in question.

More specifically, one of the at least three arithmetic units can function as a “master” arithmetic unit and the other arithmetic units can function as “slave” arithmetic units.

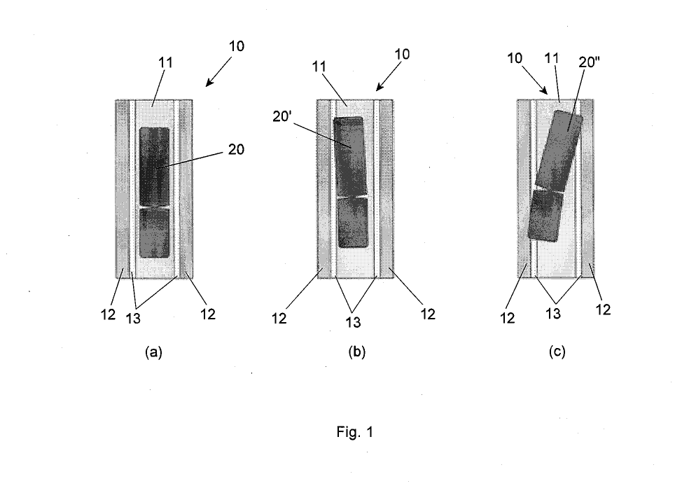

FIGS. 1a-1c are sketches showing the position of an automatically guided and steered vehicle 20 that follows a predefined path, being steered by a steering arrangement. The vehicle 20 is automatically guided and steered by means of a steering arrangement and can in principle be operated without a driver.

In a public transport system in which a vehicle 20 is automatically guided and steered by a steering arrangement supported by necessary control equipment, the path to be followed is usually a lane not intended for use by other road users, which lane is indicated at 10 in FIGS. 1a-1c. The lane is usually divided into a number of subsections 11-12-13, which are used by the path tracking system of the vehicle 20. Two lane sections 12 are defined on either side of the lane 10, between which lane sections the vehicle 20 is to move. The lane sections 12 can be regarded as forbidden areas for the vehicle 20, and consequently they are known as such to the path tracking system of the steering arrangement. Numeral 13 indicates an intermediate section, whilst the actual driving section is indicated at 11.

During normal operation of the path tracking system and the steering arrangement, the vehicle 20 can or is allowed to be present or move within the driving section 11 while normally following the predefined path.

FIG. 1a is indicated as a normal operating state, in which the vehicle 20 follows the predefined path in the driving section 11.

In general, the steering arrangement of an automatically guided and steered vehicle 20 comprises a path tracking system in which information characteristics or way points of the path to be followed are stored. Such a path tracking system is usually provided with an image or a map on which the path to be followed is projected in the form of way points. In addition to that, the steering arrangement is provided with so-called path sensor means, which determine the position of the vehicle relative to the path to be followed while the automatically guided and steered vehicle 20 follows the predefined path in the driving section 11. The position detected by the path sensor means is used for determining a possible deviation from the path, on the basis of which necessary control signals for the steering means are generated for correcting the vehicle's deviation from the path.

A deviation from the path that is irresponsibly large is shown in FIG. 1b, in which the vehicle 20′, for reasons unknown, moves into the section 13, which deviation will be detected and subsequently be corrected by generating suitable corrective control signals to the steering arrangement and by carrying out a braking action on the wheels of the vehicle. In this way the vehicle's steerage will be continuously adjusted, so that the vehicle will follow the predefined path in the driving section 11.

FIG. 1c shows a situation in which the vehicle 20′, due to unforeseen circumstances, has deviated from the predefined path to such an extent that it leads to a dangerous traffic situation. Usually, such a situation develops upon failure of (part of) the steering arrangement, as a result of which the vehicle is no longer being guided, causing it to deviate from its predefined path.

If the speed of the vehicle 20′ is high at the moment of failure of the steerage, the deviation from the predefined path (the driving section 11) may be unacceptably large, which will inevitably lead to accidents. In such a situation it is desirable that the vehicle, which is no longer being guided in that case, be stopped as soon as possible.

The disclosed embodiments provide a solution in this regard, as the steering arrangement is provided with steering means designed to steer a first axle of the vehicle for the purpose of making corrections in the case of deviations from the path, which steering means comprise at least three drivelines, which drivelines control the first steerable axle independently of each other.

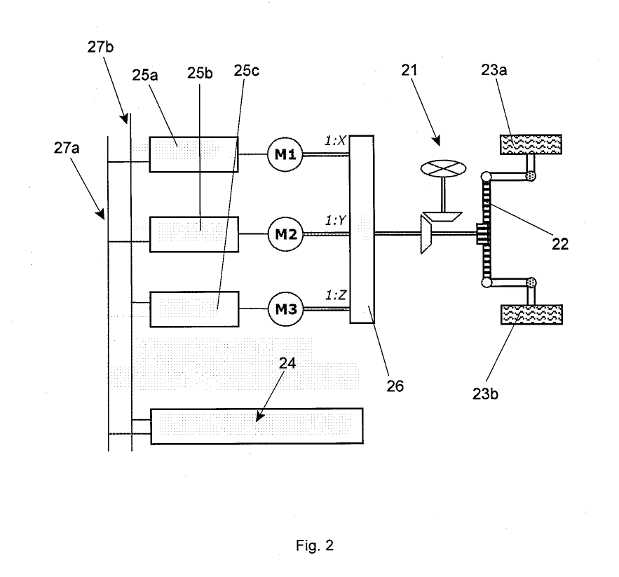

One disclosed embodiment of such a steering arrangement is shown in FIG. 2. In this figure the steering arrangement, indicated at 21, engages a first axle 22, which is in turn connected to two steerable wheels 23, 23b. For easy reference, the drawing does not include a further representation of the vehicle and/or the roadway.

The steering arrangement 21 comprises a guidance control system 24, to which measuring signals obtained from a path tracking system and route sensor means (not shown), which likewise form part of the steering arrangement 21, are supplied via signal lines 27a-27b. As already explained in the foregoing, the path tracking system is provided with information characteristics, in particular with way points forming a predefined path along which the vehicle 20 is to be moved.

The path sensor means are arranged for determining the position of the vehicle on the lane, for example, by means of (magnetic) passive markers installed in the road surface, or by means of GPS, on the basis of which a possible deviation of the vehicle from the predefined path is calculated. The data relating to speed, direction, engine speed etc are supplied to a guidance control unit 24 via the signal lines 27a-27b, which guidance control unit determines the position and the deviation from the path on the basis of the data and subsequently delivers suitable control signals to the steering arrangement 21.

The control signals may consist of corrective signals to adjust the direction of the vehicle 20 relative to the predefined path in the driving section 11.

If part of the steering arrangement fails due to unforeseen circumstances, the vehicle 20 is no longer being guided, which may lead to dangerous situations. Since a deviation can easily have disastrous consequences in particular at high vehicle speeds, it is desirable that the vehicle be stopped as soon as possible in such a precarious situation. On the other hand, it is also desirable in such a situation that the steering arrangement perform required corrective steering actions on the axle 22 to be steered while the vehicle is being stopped.

The latter is necessary because a passenger bus 20 will not come to an immediate standstill when driving at a high speed and because it must be possible in such a case to make steering adjustments yet. The steering arrangement 21 is to that end configured so that the steering means comprise at least three drivelines 25a-25b-25c, which drivelines 25a-25b-25c control the at least first axle 22 independently of each other. Each driveline comprises a drive unit 25a-25b-25c, which is controlled by the guidance control system 24 and which each control a driving motor M1-M2-M3.

The driving motors M1-M2-M3 are different from each other so as to minimize the risk of simultaneous failure due to manufacturing defects. Each driving motor M1-M2-M3 is moreover coupled to the transmission 26, using different transmission ratios 1:X, 1:Y and 1:Z, respectively, which transmission 26 is in turn connected to the first axle 22 to be steered.

In case an error in one of the drivelines 25a-25b-25c is detected by the guidance control system 24, the driveline in question will be disabled and an emergency procedure will be activated to stop the vehicle as soon as possible.

The guidance control system 24 of the steering arrangement can control the steering means 21, which are built up of the various drivelines, via separate, independent signal lines 27a-27b.The signal lines 27a-27b form a redundant and error-tolerant communication bus. The communication bus 27a controls the drivelines 25a and 25b, whilst the driveline 25c is controlled via the communication bus 27b. In case of a malfunction in a part of the multiple communication bus (for example, failure of the communication bus 27a), the guidance control system 24 will continue to control the driveline 25c via the still functioning communication bus 27b.

Furthermore, the guidance control system 24 will interfere in the brake system whilst simultaneously continuing to control the vehicle during braking, via at least one of the drivelines 25a-25b-25c that are active yet, such that the vehicle will follow the predefined path as much as possible.

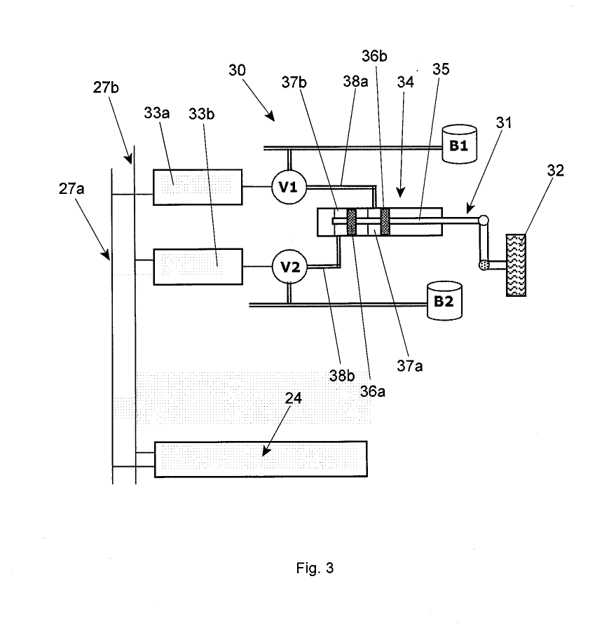

FIG. 3 shows an additional disclosed embodiment in which the steering arrangement comprises further steering means 30 designed to steer at least one further axle 31. The vehicle is not only provided with a first steering axle, therefore, but also with a further axle 31, which is also steerable. Thus, the vehicle being guided and steered along a predetermined path can also be steered by means of the further axle 31 and the wheels 32 connected thereto.

Using the further steering means 30, a path correction can be imposed on the vehicle by means of the additional steering axle 31. In an undesirable situation, a possible malfunction in the further steering means may lead to a potentially dangerous situation, in particular if the vehicle is moving at a high speed. The further steering means 30 are configured as twin steering means in this disclosed embodiment.

More specifically, the further steering means 30 are built up of two drivelines, indicated at 33a and 33b. The drivelines drive the at least one further axle 32 independently of each other. Each driveline comprises a drive unit 33a-33b, which drive units actuate a hydraulic piston/cylinder combination 34 independently of each other via servo valves V1 and V2, respectively, by means of which piston/cylinder combination the further axle 31 is steered. This prevents a situation in which the further axle is no longer being steered in case of a malfunction in the further steering means, since the drive and the steerage are immediately taken over by the other driveline.

Each trailing axle (i.e. not the front axle) comprises a (further) steering arrangement comprising two drivelines, so that the other driveline of a specific axle will keep the steering functionality intact in case of failure of one of the drivelines of a particular axle. The hydraulic piston/cylinder combination 34 is a double-acting piston/cylinder combination, which comprises a piston rod 35 that is connected to the further steering axle 31. In the cylinder, two pistons 36a-36b are mounted to the piston rod 35, which pistons divide the cylinder into two cylinder spaces 37a-37b. The cylinder space 37a is in communication with a buffer B1 for a hydraulic medium via a hydraulic line 38a and the servo valve V1. The servo valve V1, and thus the supply of hydraulic medium to the first cylinder space 37a via the line 38a, is controlled via the drive unit 33a of the first driveline. Likewise, the second cylinder space 37b is connected to a second buffer B2 for hydraulic medium via a hydraulic line 38b and the second servo valve V2.

The second servo valve V2 is controlled by the drive unit 33b. The two drive units 33a-33b are controlled by the guidance control system 24 via suitable signal lines 27a-27b. The signal lines 27a-27b form a redundant and error-tolerant communication bus. The communication bus 27a controls the driveline 33a, whilst the driveline 33b is controlled via the communication bus 27b. In case of a malfunction in a part of the multiple communication bus (for example, failure of the communication bus 27), the guidance control system 24 will continue to control the driveline 33b via the still functioning communication bus 27b.

In case of a malfunction, the remaining driveline 33b will thus be controlled in such a manner that suitable steering adjustments via the further steerable axle 31 can still be made also during braking of the vehicle, and consequently dangerous road situations can be avoided. By driving the further steering means by means of the guidance control system 24 via the redundant and error-tolerant communication bus 27a-27b, it is thus possible to stop the vehicle, during which stopping action controlled attempts will be made to keep the vehicle on the desired path by making steering adjustments.

The guidance control system 24 will to that end interfere with the brake system and, in addition to that, continue to steer the vehicle during braking via one of the still operative drivelines 33a-33b, in such a manner that the vehicle will follow the predefined path as much as possible.

Although the redundant and error-tolerant communication bus 27a-27b is represented in the form of control lines for controlling the various drivelines 25a-25c and 33a-33b in FIG. 2 (and FIG. 3), in an identical embodiment (not shown) the steering arrangement 24 comprises a redundant power source. The redundant supply source supplies power (voltage/current) to the various drivelines (and other parts of the steering arrangement) in a similar manner via various independent feed connections (or feeders).

Analogously, the guidance control system 24 will detect an unwished-for power cutoff to one of the drivelines and consequently it will control the steering device in an analogous manner as described above. The driveline in question will be disabled and the steering functionality will be retained. The vehicle will be stopped, and controlled attempts to keep the vehicle on the desired path by making steering adjustments will continue to be made.

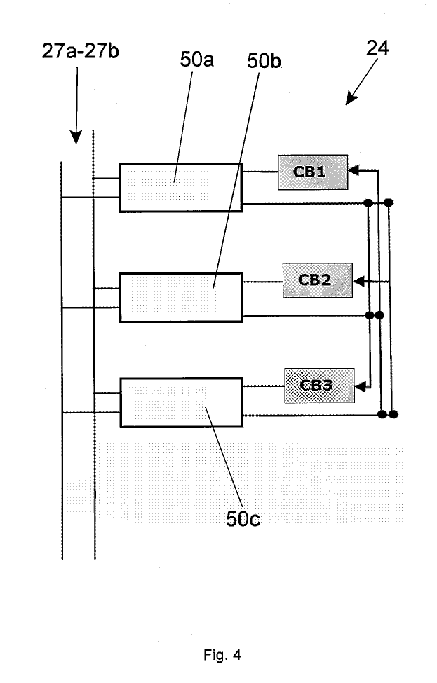

FIGS. 4-6 show a disclosed embodiment with detail views of the guidance control system 24 for controlling the steering means as described in FIGS. 2 and 3.

The guidance control system 24 is partially built up of at least three mutually checking arithmetic units 50a-50b-50c. The arithmetic units are built up in such a manner that in case of a malfunction in one of the arithmetic units, the arithmetic unit in question will be disabled and will thus no longer contribute to the control of the steering arrangement's steering means. As is clearly shown in FIG. 4, the various arithmetic units 50a-50c are connected to the various drivelines 25a-25c (FIGS. 2) and 33a-33b (FIG. 3) of the steering arrangement by means of signal lines 27a-27b of the redundant communication bus.

In use, each arithmetic unit 50a-50c generates control signals for the drivelines. The control signals are interpretations for the relevant arithmetic unit 50a-50c how the steering arrangement 21, and thus the vehicle 20, is to be guided along the predefined path.

As a result of the multiple redundant configuration of the guidance control system, the arithmetic units generate such control signals independently of each other. The redundant configuration enables the various arithmetic units to generate mutually different control signals. This implies a different interpretation of the steering action to be taken by the steering arrangement.

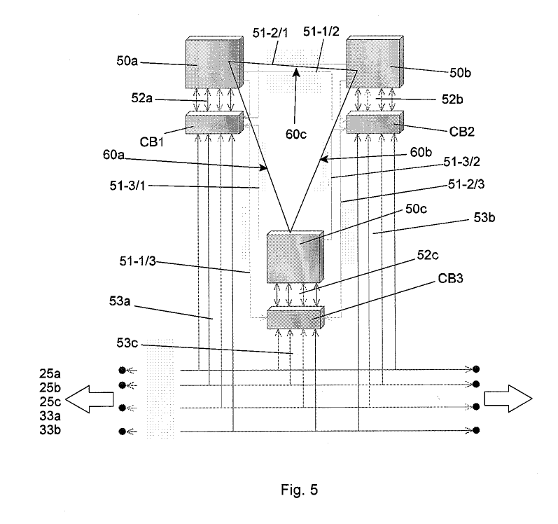

Each control signal is transmitted to the other arithmetic units via “peer-to-peer” signal lines 60a-60b-60c (see FIG. 5).

Each arithmetic unit 50a-50b-50c is designed to compare the respective control signals from each of the other arithmetic units with its own generated control signal. During this comparison, each arithmetic unit will consider whether its own interpretation of the current operating state of the steering arrangement corresponds to the interpretation by the other au. The comparison made by an arithmetic unit of its own control signal with the control signal from each of the other arithmetic units results in the generation by the arithmetic unit of a verification signal for the arithmetic unit in question (with whose control signal the control signal has been compared).

In other words, each arithmetic unit 50a-50c generates two verification signals for the other arithmetic units. This is shown in FIG. 5, in which the arithmetic unit 50a generates a verification signal 51-1/2 on the basis of the comparison of the control signal from the arithmetic unit 50a with the control signal from the second arithmetic unit 50b. Likewise, the arithmetic unit 50a will generate a verification signal 51-1/3 on the basis of the comparison of the control signal generated by the arithmetic unit 50a with the control signal from the arithmetic unit 50c.

Likewise, the arithmetic unit 50b will generate two verification signals 51-2/1 and 51-2/3, respectively, upon comparison of its own control signal with that from the first arithmetic unit 50a and the third arithmetic unit 50c, respectively.

Likewise, the arithmetic unit 50c will generate two verification signals 51-3/1 and 51-3/2, respectively, upon comparison of its own control signal with that from the first arithmetic unit 50a and the second arithmetic unit 50b, respectively.

Each verification signal is a logic signal which may have a positive or a negative value, also referred to as a 1-signal or a 0-signal.

Each of the arithmetic units will deliver a positive verification signal for another arithmetic unit if it appears from a comparison of the control signals that the two arithmetic units have detected a corresponding or identical (interpreted) current operating state of the steering arrangement. In such a situation the two arithmetic units are in the same functional operating state.

If an arithmetic unit determines upon the comparison that the control signal from the arithmetic unit in question represents a different current operating state than the operating state it has itself determined, the arithmetic unit will deliver a negative verification signal for the arithmetic unit in question. This means that the respective arithmetic units have different views (or interpretations) regarding the current operating state of the steering arrangement.

By way of example it can be noted that one arithmetic unit interprets the current operating state as implying that the steering arrangement must steer the vehicle in a straight line, whereas the other arithmetic unit interprets the same current operating state as implying that the steering device must impose the steering action to, for example, the left on the vehicle.

In such a situation the arithmetic units have clearly different interpretations of how the steering arrangement and the vehicle are to be controlled, which may lead to an undesirable if not dangerous situation. In such a situation one of the arithmetic units is mistaken and needs to be disabled.

In order to determine which arithmetic unit has incorrectly interpreted the current operating state, each of the verification signals generated by each of the two arithmetic units for the other arithmetic unit is supplied as an input signal to an authorization unit for the arithmetic unit in question.

In FIGS. 4 and 5, the authorization units are indicated at CB-1, CB-2 and CB-3, respectively.

As FIG. 5 clearly shows, the authorization unit CB-1 associated with the first arithmetic unit 50a receives the verification signals 51-2/1 and 51-3/1 generated by the second arithmetic unit 50b and the third arithmetic unit 50c, respectively, as the result of the comparison of the current operating state of the steering arrangement interpreted by the first arithmetic unit 50a on the one hand and the second and the third arithmetic unit 50b and 50c, respectively, on the other hand.

Likewise, the authorization unit CB2, CB3 associated with the second arithmetic unit 50b and the third arithmetic unit 50c, respectively, receives verification signals 51-2/2 and 51-3/2 (51-1/3 and 51-2/3, respectively) from the first arithmetic unit 50a and the third arithmetic unit 50c, respectively (the first arithmetic unit 50a and the second arithmetic unit 50b, respectively).

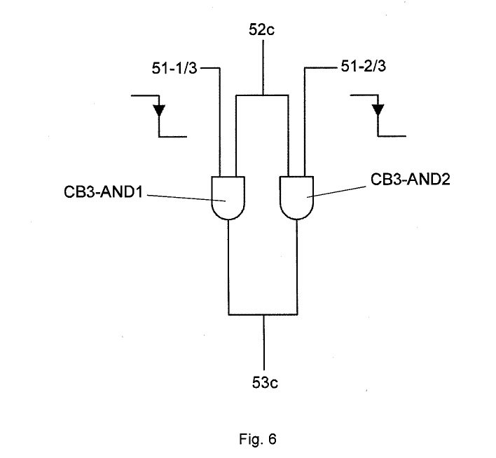

As shown in FIG. 6, each authorization unit CB1-CB2-CB3 is built up of logic AND gates CB3-AND1 and CB3-AND2, respectively.

The authorization unit CB3 will now be explained by way of example with reference to FIG. 6.

The authorization unit CB3 is designed to determine whether or not the third arithmetic unit 50c must be disabled as a consequence of a malfunction in the arithmetic unit 50c detected by the steering arrangement.

In case of a malfunction occurring in the arithmetic unit 50c, the arithmetic unit 50c will incorrectly interpret the current operating state of the steering arrangement, and accordingly it will also deliver a control signal that differs from the control signals from the correctly functioning arithmetic units 50a-50b.

This incorrect interpretation of the current operating state by the third arithmetic unit 50c will be interpreted and compared by the two arithmetic units 50a and 50b, respectively, resulting in the delivery of negative verification signals 51-1/3 and 51-2/3, respectively (by the second arithmetic unit 50b).

The verification signals in question are so-called logic signals, being a 0-signal in the case of a negative comparison (and a 1-signal in the case of a positive comparison). Each verification signal 51-1/3, 51-2/3 functions as an input signal for a logic AND gate, indicated at CB3-AND1 and CB3-AND2, respectively, in FIG. 6. The other input port of each logic AND gate receives the control signal that has been generated by the respective arithmetic unit 50c itself.

This control signal is carried to the two AND gates via the signal line 52c. In the case of a negative verification signal delivered by the first arithmetic unit 50a (the signal 51-1/3 is a so-called 0-signal), the AND gate CB3-AND1 in question is fed a 0-signal and a 1-signal, respectively (the 1-signal is received from the third arithmetic unit 50c itself, via the signal line 52c). In response to the 0- and 1-signals being input, the CB3-AND1 gate will deliver a 0-signal and thus disable the transfer of control signals from the third arithmetic unit 50c via the signal lines 53 in the direction of the communication bus and the various drivelines 25a-25c and 33a-33b.

In the situation in which the second arithmetic unit 50b has delivered a negative verification signal 51-2/3 as well, the second AND gate CB3-AND2 is fed a 1-signal (via the signal line 52c of the third arithmetic unit 50c itself) and a 0-signal (verification signal 51-2/3). Accordingly, also the second AND gate CB3-AND2 will deliver a 0-signal on the signal line 53c, thus completely disabling the arithmetic unit 50c and prevent further communication or the transfer of control signals to the communication bus and the drivelines by the third arithmetic unit.

If only one arithmetic unit delivers a negative verification signal for the arithmetic unit in question (and the other arithmetic unit delivers a positive verification signal for the arithmetic unit, therefore), only one of the AND gates will get in the blocking state, whereas the other AND gate will allow (pass-through state) the transfer of control signals from the arithmetic unit in question to the communication bus.

In this situation, it is likely that the arithmetic unit that has delivered the negative verification signal exhibits an internal malfunction itself and consequently is no longer functioning correctly. After all, the other two arithmetic units interpret the current operating state identically. In that situation the other arithmetic unit, which delivered the deviating verification signal, will be disabled in a corresponding manner by the verification signals generated for the non-functioning arithmetic unit by the other two arithmetic units.

If the arithmetic unit is the unit that functions as the “master”, one of the remaining arithmetic units will take over the “master” functionality with a “slave” function.

The moment one of the arithmetic units 50a-50c is disabled in the above-described manner, the entire steering arrangement will exhibit a loss of redundancy and no longer be fail-operational. According to the disclosed embodiments, the guidance control system 24 will stop the vehicle (by actuating the brake system) in such a situation.

1. A steering arrangement for a vehicle which is movable along a predefined path in use, being automatically steered via at least one first axle, the steering arrangement comprising:
a path tracking system comprising information characteristics relating to the predefined path to be followed;
path sensor means designed to detect a deviation from the predefined path by the vehicle;
steering means designed to steer the at least first axle so as to correct the detected deviation from the path; and
a guidance control system for controlling the steering means, wherein the guidance control system comprises at least three mutually verifying arithmetic units, such that, in case of a detected malfunction in one of the arithmetic units, the other arithmetic units will disable the arithmetic unit in question.

2. The steering arrangement of claim 1, wherein each arithmetic unit generates a control signal during operation, which control system is characteristic of the current operating state of the steering arrangement as determined by the arithmetic unit in question, which control signal serves as an input signal for the other arithmetic units.

3. steering arrangement of claim 2, wherein each arithmetic unit compares each control signal from the arithmetic unit in question that is input with the control signal it has generated itself, and on the basis of this comparison it generates a verification signal for the arithmetic unit in question.

4. The steering arrangement of claim 3, wherein each arithmetic unit generates a positive verification signal in the case of corresponding control signals.

5. The steering arrangement of claim 3, wherein each arithmetic unit generates a negative verification signal in the case of non-corresponding control signals.

6. The steering arrangement of claim 3, wherein each verification signal generated for a respective arithmetic unit serves as an input signal for an authorization unit for the arithmetic unit in question.

7. The steering arrangement of claim 6, wherein each authorization unit can be put in a pass-through state or a blocking state partially on the basis of the input verification signals.

8. The steering arrangement of claim 6, wherein each authorization unit comprises at least one AND gate provided with an input for a verification signal.

9. The steering arrangement of claim 8, wherein each authorization unit comprises at least one second AND gate provided with an input for at least one other verification signal.

10. The steering arrangement of claim 8, wherein each AND gate is provided with a further input for a verification signal generated by the arithmetic unit in question.

11. The steering arrangement of claim 1, wherein one of the at least three arithmetic units functions as a “master” arithmetic unit.

12. The steering arrangement of claim 11, wherein the other arithmetic units function as “slave” arithmetic units.

13. The steering arrangement of claim 1, wherein the guidance control system comprises a redundant and error-tolerant communication bus.

14. The steering arrangement of claim 1, wherein the guidance control system will stop the vehicle upon detection of a malfunction in the steering arrangement.

15. A vehicle provided with a steering arrangement according to claim 1.
